(19) United States
(12) Patent Application Publication
(10) Pub. No.: US 2008/0303680 A1
(43) Pub. Date: Dec. 11, 2008

(54) Display for Active Power Filter

(76) Inventors: Wen Hsu, Kaohsiung (TW); Nan-Tsun Shen, Kaohsiung (TW); Wen-Pin Hsu, Kaohsiung (TW); Min-Sheng Huang, Kaohsiung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/845,507

(22) Filed: Aug. 27, 2007

(30) Foreign Application Priority Data
Jun. 11, 2007 (TW) 096120972

(51) Int. Cl. G08B 5/00

(52) U.S. Cl. 340/653

(57) ABSTRACT

A display for active power filter can be employed to show setting compensation parameters and real compensating information of the active power filter in operation in a same screen. Accordingly, the users can immediately diagnose whether resonance or other problem was appeared or not.

### BACKGROUND OF THE INVENTION

1. Field of the Invention

The present invention relates to a display for an active power filter. More particularly, the present invention relates to a display having a screen that is provided for setting compensation parameters and observing the real compensating information for each harmonic order. Additionally, when the active power filter is in operation and at least one order harmonic is uncompensated due to the existence of resonance or other problems, an alarm occurs and the uncompensated order harmonic will be displayed in the screen.

2. Description of the Related Art

Nowadays, the active power filters have been widely used in many applications. Therefore, the active power filters often requires much more complex and useful functions.

However, a conventional active power filter generally uses lamps to notify the users to get some information such as being in operation, in filtering, in fault and so on, and there may merely be an additional sound alarm for notifying at most. When the conventional active power filter is in operation, the lamps and the alarm were usually unable to provide detailed information to users for identifying. Therefore, the users are often unable to quickly and easily set predetermined compensation parameters for each harmonic order and cannot immediately and correctly observe the real compensating information of the active power filter either.

In some other advanced active power filters, a matrix type graphic display of said active power filter is provided for showing much more information. However, without showing the setting compensation parameters and the real compensating information in operation in a same screen, the matrix type graphic display often shows one of the setting compensation parameters and the real compensating information only, that is, when the setting compensation parameters are shown in the screen of the matrix type graphic display, the real compensating information of the active power filter will not be shown in the same screen. Therefore, the users need to switch between two different screens respectively to show the setting compensation parameters and the real compensating information, and the users also need to switch between two different screens to set the compensation parameters and observe the real compensating information respectively. Accordingly, the matrix type graphic display is inconvenient for operation.

In order to improve the aforementioned disadvantage, the present invention intends to provide a display for the active power filter so as to show both the setting compensation parameters and the real compensating information in operation in a same screen. Furthermore, if at least one order harmonic is uncompensated due to the existence of resonance or other problems, there will be an alarm to be applied for informing the users about the uncompensated order harmonic information in the same screen. Accordingly, the users can quickly and easily set the setting compensation parameters for each harmonic order and immediately and correctly observe the real compensating information so as to further diagnose whether resonance or other problem was appeared or not.

### SUMMARY OF THE INVENTION

The primary objective of this invention is to provide a display for active power filter. A display is employed to provide the users for quickly and easily setting the setting compensation parameters in a screen. Furthermore, when an active power filter is operated, the real compensating information can also be observed in the same screen. Accordingly, the users can immediately diagnose whether resonance or other problem was appeared or not.

Further scope of the applicability of the present invention will become apparent from the detailed description given hereinafter. However, it should be understood that the detailed description and specific examples, while indicating preferred embodiments of the invention, are given by way of illustration only, since various will become apparent to those skilled in the art from this detailed description.

### BRIEF DESCRIPTION OF THE DRAWINGS

The present invention will become more fully understood from the detailed description given hereinbelow and the accompanying drawing which is given by way of illustration only, and thus is not limitative of the present invention, and wherein:

FIG. 1 is a schematic diagram of a display for active power filter in accordance with the present invention.

### DETAILED DESCRIPTION OF THE INVENTION

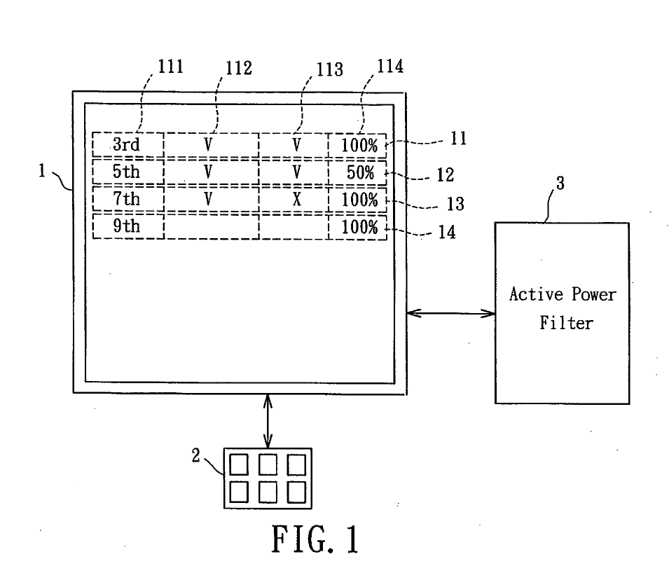

Referring to FIG. 1, a schematic diagram of a display 1 for an active power filter 3 in accordance with a preferred embodiment of the present invention is illustrated. The display 1 connects between an input panel 2 and the active power filter 3. The display 1 can be employed to show predetermined input information, such as setting compensation parameters of specified harmonic orders of the active power filter 3 inputted by the input [symbol] panel 2, and real compensating information of the active power filter 3 in operation in a same screen. The setting compensation parameters and the real compensating information can be shown via characters, digits, and graphs.

Referring again to FIG. 1, a plurality of rows is incorporated in the screen of the display 1. The rows represent the information of corresponding harmonic orders. Particularly, in the preferred embodiment of the present invention, the number of the rows is N for showing the users the related information of N harmonics in a screen simultaneously. That is, the display 1 comprises a first row 11, a second row 12, a third row 13, a fourth row 14, and an n^{th} row. Each row further comprises a plurality of terms. For example, in the present invention, the first row 11 further comprises four terms 111, 112, 113, 114, and the four terms 111, 112, 113, 114 are employed to respectively show the compensation parameters setting inputted by the input panel 2 and the real compensating information of the active power filter 3 in operation.

More particularly, the first term 111 is employed to show the harmonic order. For example, when “3rd” is shown in the first term 111, it indicates the third order of harmonic for the active power filter 3.

Still referring to FIG. 1, the second term 112 is employed to show whether the harmonic order showing at the first term 111 will be compensated or not. The users can set the compensation parameters with graphs or characters in the second term 112 to show whether the harmonic order will be compensated or not before operating the active power filter 3. For example, if the harmonic order shown in the first term 111 is selected to be compensated, the users set a symbol “V” in the second term 112. Conversely, if the harmonic order shown in the first term 111 will not be compensated, the second term 112 will be kept to be blank.

Referring again to FIG. 1, the fourth term 114 of the first row 11 is employed to show a ratio of setting compensating capacity for the harmonic order shown in the first term 111. The ratio can be represented with digits or graphs. For example, if the users desire the active power filter 3 compensating full capacity for the harmonic order shown in the first term 111, the users can set “100%” in the fourth term 114 by using the input panel 2 before operating the active power filter 3. Similarly, if the users desire the active power filter 3 compensating half capacity for the harmonic order shown in the first term 111, the users can set “50%” in the fourth term 114 by using the input panel 2 before operating the active power filter 3.

Referring again to FIG. 1, when the users have accomplished the compensation parameters setting in the second term 112 and the fourth term 114 of harmonic order shown in the first terms 111 respectively, the active power filter 3 will be operated according to the compensation parameters setting. The third term 113 of the first row 11 can be employed to show the real compensating information for the harmonic order shown in the first terms 111.

Additionally, when the active power filter 3 compensates the specific harmonic order shown in the first term 111 according to the setting compensation parameters shown in the second term 112 and the fourth term 114, a resonance may occur. The active power filter 3 will therefore stop compensating the specific harmonic order shown in the first term 111. Meanwhile, the third term 113 will respond to the real compensating information of the active power filter 3 according to the mentioned operation.

For example, when the active power filter 3 is operated to filter out the specific harmonic order shown in the first term 111 that is completely according to the compensation parameters setting in the second term 112 and the fourth term 114, the third term 113 shows a graph “V”. Conversely, when the active power filter 3 is unable to completely filter the specific harmonic order according to the compensation parameters setting in the second term 112 and the fourth term 114, the third term 113 shows another graph “X”. At the same time, there will be an alarm occurred and represented in the first row 11 to notify the users, such that the users can quickly observe the above abnormal operation, wherein the alarm can be represented in form of flashing characters or graphs in at least one of the terms 111, 112, 113, 114.

Furthermore, if the second term 112 and the fourth term 114 are not set in the compensation parameters setting for the specific harmonic order shown in the first term 111, the third term 113 will not show any real compensating information when the active power filter 3 is operated.

Referring again to FIG. 1, in the preferred embodiment of the present invention, the second row 12 to the n^{th} row 1N can be operated in the same way as the first row 11 do, so as to let the users set the compensation parameters setting and observe the real compensating information for other harmonic orders in the same screen.

Referring again to FIG. 1, the display 1 of the present invention can not only provide the users to set the compensation parameters setting in the second term 112 and fourth term 114, but also observe the real compensating information from the third term 113. Accordingly, the users can immediately diagnose whether resonance or other problem was appeared or not according to the unable compensated harmonic order showing at the display 1.

As has been discussed above, the conventional matrix type graphic display needs to be switched between two different screens for setting the setting compensation parameters and observing the real compensating information respectively. Therefore, it is inconvenient for operation. Conversely, the display 1 in accordance with the present invention is able to represent both the setting compensation parameters and the real compensating information of the active power filter 3 in a screen thereof. Therefore, the users can input the setting compensation parameters through the input panel 2 and observe the real compensating information in operation without switching the screen. Consequently, the users can immediately and conveniently operate the display 1.

Although the invention has been described in detail with reference to its presently preferred embodiment, it will be understood by one of ordinary skill in the art that various modifications can be made without departing from the spirit and the scope of the invention, as set forth in the appended claims.

What is claimed is:

1. A display for active power filter comprising:
a plurality of rows employed to simultaneously show setting compensation parameters inputted through an input panel and real compensating information of the active power filter in operation in a screen,
wherein the rows represent the information of corresponding harmonic orders.

2. The display for active power filter as defined in claim 1, wherein each row comprises a first term, a second term, a third term, and a fourth term.

3. The display for active power filter as defined in claim 2, wherein the first term is employed to show a harmonic order.

4. The display for active power filter as defined in claim 2, wherein the second term is employed to show whether the harmonic order showing at the first term will be compensated or not.

5. The display for active power filter as defined in claim 2, wherein the third term is employed to show the real compensating information of the harmonic order shown in the first term.

6. The display for active power filter as defined in claim 2, wherein the fourth term is employed to show a ratio of setting compensating capacity for the harmonic order shown in the first term.

7. The display for active power filter as defined in claim 1, wherein an alarm is activated in the row when the active power filter is unable to completely compensate for the corresponding harmonic order according to the ratio of setting compensating capacity in the fourth term.
